(19) United States
(12) Patent Application Publication
(10) Pub. No.: US 2013/0235575 A1
(43) Pub. Date: Sep. 12, 2013

(54) LED LIGHT MODULE

(71) Applicants: Chia-Tsung TSAO, Taipei (TW); Chan-Ching LIN, New Taipei City (TW)

(72) Inventors: Chia-Tsung TSAO, Taipei (TW); Chan-Ching LIN, New Taipei City (TW)

(73) Assignee: ARTLED TECHNOLOGY CORP.

(21) Appl. No.: 13/417,959

(22) Filed: Mar. 12, 2012

(51) Int. Cl. F21V 21/00; F21V 17/08; F21V 31/00; F21V 17/06

(52) U.S. Cl. 362/235

(57) ABSTRACT

An LED light module has a mounting board and multiple LED lights mounted securely on the mounting board. Each LED light has a casing, a lighting module and two resilient sheets. The lighting module is mounted in the casing. The resilient sheets are mounted on an outside wall of the casing and abut an annular edge around a mounting hole of the mounting board. The LED lights are mounted securely on the mounting board by the resilient force of the resilient sheets, so the user only has to push the LED light to resist the slightly resilient force, and the LED light can be disassembled from the mounting board. Thus, any individual LED light can be easily disassembled.

### BACKGROUND OF THE INVENTION

1. Field of the Invention

The present invention relates to an LED light module, especially to an LED light module wherein any individual LED light of the LED light module can be easily disassembled.

2. Description of the Prior Arts

Light Emitting Diode (LED) is a semiconductor light source. LED has many advantages such as high efficiency, long life span, durability against breaking, quickness in reaction and high reliability, and the LED light has replaced the conventional light gradually.

The LED light has a variety of utilities, one of which is for use in the advertisement billboard. When used in a billboard, multiple LEDs with a mounting board constitute an LED light module. The LED lights are mounted on the mounting board and are arranged in order to form an illustration or a character. Because the illustration or character comprises LED lights, even if only one LED light is damaged, the broken LED light would cause a serious impact on the whole illustration or character. As a result, the broken LED light has to be repaired or replaced as soon as possible.

However, the LED light cannot be separated from the mounted board easily in the conventional LED light module, so the user needs to remove the whole LED light module even only one LED light is damaged, and it causes great inconvenience, especially because the billboard is often mounted on a high place. The operation and transportation of the LED light module is more inconvenient

To overcome the shortcomings, the present invention provides an LED light module to mitigate or obviate the aforementioned problems.

### SUMMARY OF THE INVENTION

The main objective of the present invention is to provide an LED light module wherein any individual LED light of the LED light module can be easily disassembled.

The LED light module in accordance with the present invention has a mounting board and multiple LED lights mounted securely on the mounting board. Each LED light has a casing, a lighting module and two resilient sheets. The lighting module is mounted in the casing. The resilient sheets are mounted on an outside wall of the casing and abut an annular edge around a mounting hole of the mounting board. The LED lights are mounted securely on the mounting board by the resilient three of the resilient sheets, so the user only has to push the LED light to resist the slightly resilient force, and the LED light can be disassembled from the mounting board. Thus, any individual LED light can be easily disassembled.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED light module in accordance with the present invention;

FIG. 2 is a partially exploded perspective view of the LED light module in FIG. 1;

FIG. 3 is a partially exploded perspective view of the LED light module in FIG. 1;

FIG. 4 is a partially exploded perspective view of the LED light module in FIG. 1;

FIG. 5 is a side view in partial section of the LED light module in FIG. 1;

FIG. 6 is an enlarged perspective view of the LED light module in FIG. 1;

FIG. 7 is an operational side view in partial section of the LED light module in FIG. 1, showing a route of the light;

FIG. 8 is an operational side view of the LED light module in FIG. 1, showing that the user operates from the back of the LED light module;

FIG. 9 is an operational view of the LED light module in FIG. 1, showing the first act of the disassembling from the back of the LED light module;

FIG. 10 is an operational view of the LED light module in FIG. 1, showing the second act of the disassembling from the back of the LED light module;

FIG. 11 is an operational view of the LED light module in FIG. 1, showing the third act of the disassembling from the back of the LED light module;

FIG. 12 is an operational side view of the LED light module in FIG. 1, showing that the user operates from the front of the LED light module;

FIG. 13 is an operational view of the LED light module in FIG. 1, showing the first act of the disassembling from the front of the LED light module;

FIG. 14 is an operational view of the LED light module in FIG. 1, showing the second act of the disassembling from the front of the LED light module; and

FIG. 15 is an operational view of the LED light module in FIG. 1, showing the third act of the disassembling from the front of the LED light module.

### DETAILED DESCRIPTION OF THE PREFERRED EMBODIMENTS

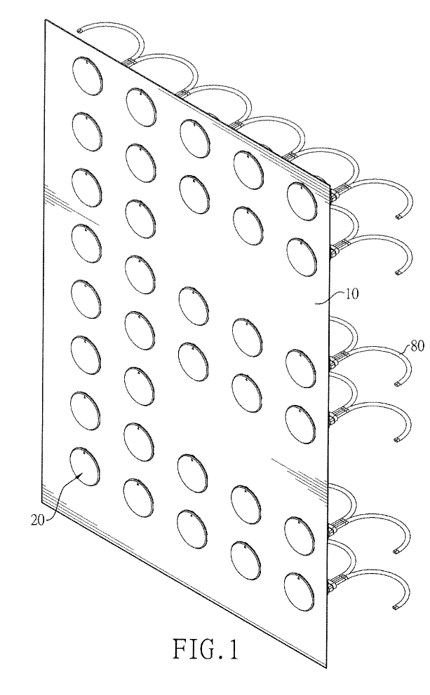

With reference to FIG. 1, an LED light module in accordance with the present invention comprises a mounting board 10 and multiple LED lights 20.

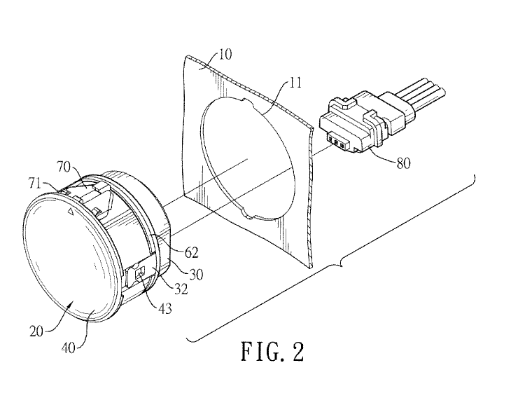

With reference to FIGS. 1 and 2, the mounting board 10 has multiple mounting holes 11.

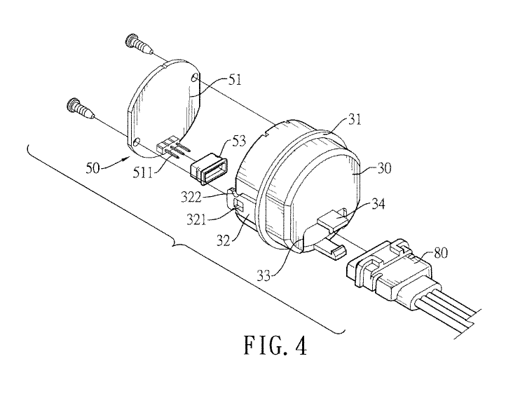

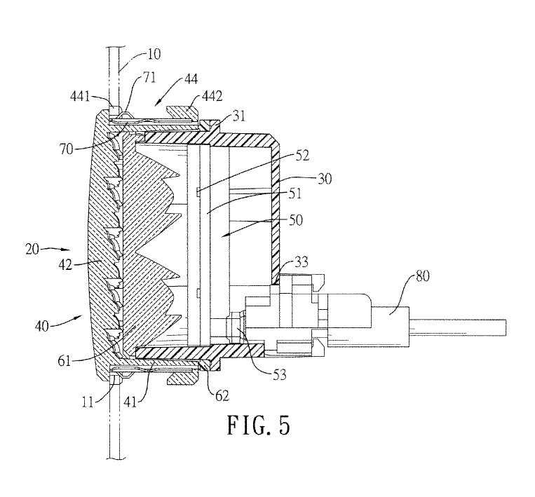

With reference to FIGS. 2 to 5, the multiple LED lights 20 are respectively mounted securely in the mounting holes 11 of the mounting board 10, and each LED light 20 has a casing, a lighting module 50, a waterproof gasket 62, and two resilient sheets 70. In a preferred embodiment, each LED light 20 further has a refraction lens 61.

The casing is mounted in one of the mounting holes 11 of the mounting board 10, and has a back cover 30, a front cover 40 and an inner cavity. The back cover 30 has two back buckling segments 32 and a power hole 33. In a preferred embodiment, the back cover 30 has an inner cavity, a front side opening and an annular flange 31 formed annularly around an outside wall of the back cover 30. The back buckling segments 32 are formed on the annular flange 31, and each back buckling segment 32 has a buckling hole 321 and two separating recesses 322. The separating recesses 322 are respectively formed in two opposite sides of the back buckling segment 32. The back cover 30 has two buckles 34 formed oppositely on an annular edge around the power hole 33 of the back cover 30.

The front cover 40 has a lens segment 42 and two front buckling segments 43. The lens segment 42 is transparent and is formed on a front side of the front cover 40. The front buckling segments 43 respectively engage with the back buckling segments 32. In a preferred embodiment, a backside of each front buckling segment 43 is a slope. A diameter of the lens segment 42 is bigger than a diameter of the mounting hole 11 of the mounting board 10. The lens segment 42 has two slope recesses 421 formed in a periphery of the lens segment 42. The front cover 40 covers the opening of the back cover 30, and has a surrounding wall 41. The surrounding wall 41 is mounted in the mounting hole 11 of the mounting board 10, has an inner cavity and two side openings, and is mounted around the back cover 30. The front cover 40 further has two connecting segments 44 formed on an outside wall of the surrounding wall 41, and each connecting segment 44 has a front protrusion 441 and a back protrusion 442. The front side of the back protrusion 442 is a slope.

The inner cavity of the casing is formed between the front cover 40 and the back cover 30.

The lighting module 50 is mounted in the inner cavity of the casing, and has a circuit board 51 and at least one LED 52 mounted on the circuit board 51. In a preferred embodiment, the lighting module 50 has multiple LEDs 52, and the LEDs 52 have at least two different colors. The lighting module 50 has multiple pins 511 and a pin gasket 53. The pins 511 are formed on a backside of the circuit board 51. The pin gasket 53 is mounted on the backside of the circuit board 51, and is mounted around the pins 511.

The refraction lens 61 is mounted in the inner cavity of the casing, and is mounted between the lens segment 42 of the front cover 40 and the lighting module 50.

The waterproof gasket 62 is mounted on the casing, and is mounted between the front cover 40 and the back cover 30. In a preferred embodiment, the waterproof gasket 62 is mounted around the back cover 30, and is clamped between the annular flange 31 of the back cover 30 and the surrounding wall 41 of the front cover 40.

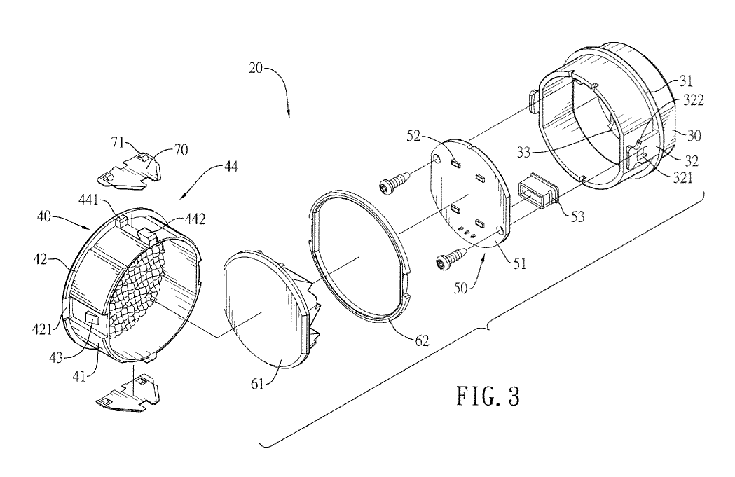

With reference to FIGS. 3, 5 and 6, the resilient sheets 70 are mounted on an outside wall of the casing, and abut an annular edge around the corresponding mounting hole 11 of the mounting board 10. In a preferred embodiment, the resilient sheets 70 are mounted on the outside wall of the surrounding wall 41 of the front cover 40. The resilient sheets 70 respectively engage with the connecting segments 44 of the front cover 40, and each resilient sheet 70 engages between the front protrusion 441 and the back protrusion 442. Each resilient sheet 70 has an abutting segment 71, and the mounting board 10 is clamped between the abutting segment 71 and the lens segment 42 of the front cover 40.

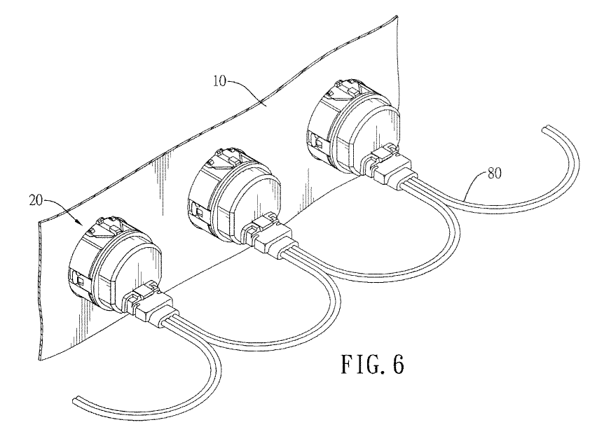

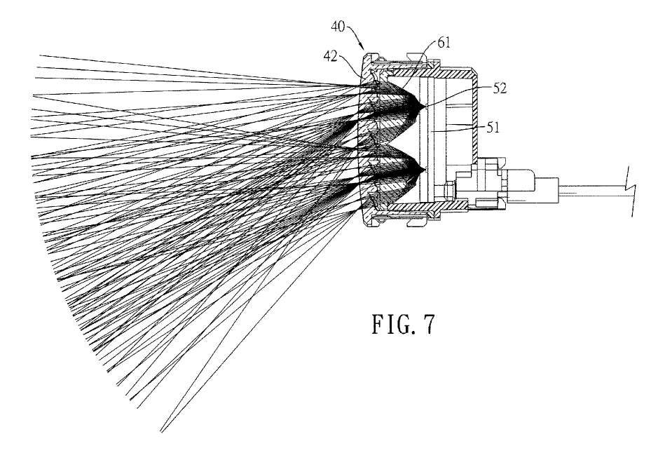

With reference to FIGS. 2 and 4 to 6, when the LED light module as described is used, the LED lights 20 are mounted in the mounting holes 11 of the mounting board 10 from the front side, and the resilient sheets 70 of each LED light 20 abut the mounting board 10. Then, the power cord 80 is mounted through the power hole 33 of the back cover 30 of the LED light 20, is attached to the pins 511 of the circuit board 51, and engages the buckles 34 around the power hole 33. With the pin gasket 53 mounted around the place where the power cord 80 is attached to the pins 511, the pin gasket 53 provides a waterproof effect. In a preferred embodiment, the LED lights 20 are in series connection by the power cord 80 as shown in FIG. 6. When the LED light 20 is used, the LEDs 52 on the circuit board 51 are operated, and the light from the LEDs 52 passes through the refraction lens 61 and the lens segment 42 of the front cover 40. The light gets refracted and shines downward and obliquely as shown in FIG. 7. As a result, when the present invention is mounted on a high place, people on the ground can easily see the downward light.

A conventional billboard tends to be huge, so the billboard is often mounted on the top of a building. Besides, the billboard is often mounted on a periphery of the top floor, so the building would not block the billboard. The billboard is installed in two ways:

First, a stationary maintenance route is mounted behind the billboard, so the maintenance route would not block the billboard.

Second, a removable maintenance route is mounted in front of the billboard, but is installed only when the billboard needs maintenance work.

The present invention applies to the above two ways, and the LED lights 20 can be disassembled in two directions.

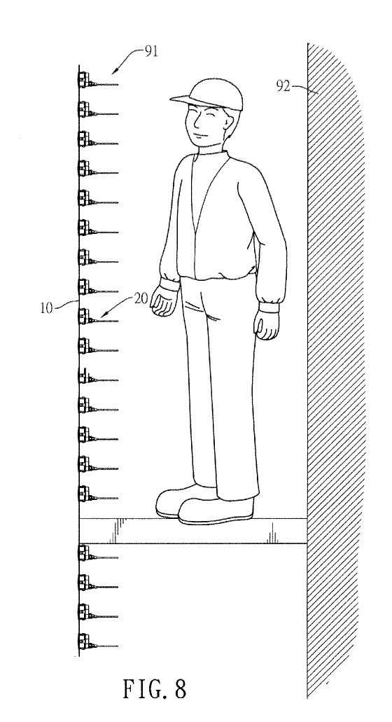

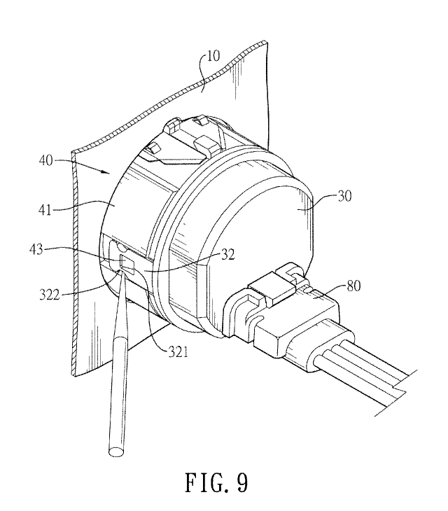

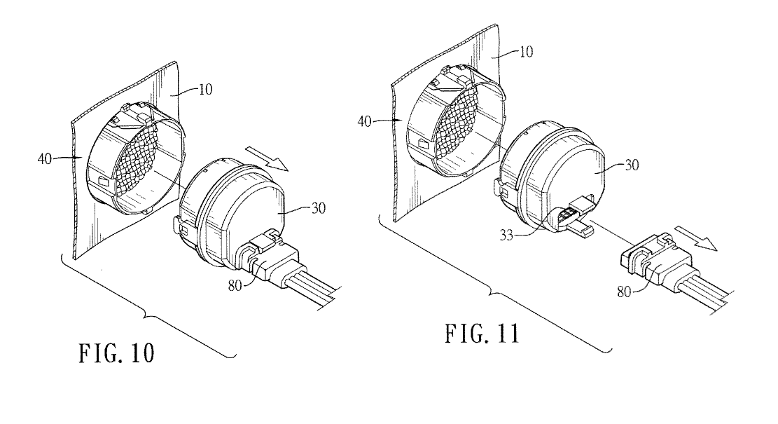

One disassembling direction is to disassemble the LED lights from the back of the mounting board 10. With reference to FIGS. 8 to 11, when a distance between the billboard and the building is adequate as shown in FIG. 8, the user can operate in the back of the back cover 30. After pulling and opening a front side of the back buckling segment 32, the buckling hole 321 of the back buckling segment 32 is departed from the front buckling segment 43 of the front cover 40, so the back cover 30 can be disassembled from the back of the mounting board 10. Besides, the user also can use a sharp object to prick into the separating recess 322 and open the back buckling segment 32 as shown in FIG. 9. Then after the power cord 80 is departed from the lighting module and the back cover 30, the power cord 80 is connected to a new back cover 30 and a new lighting module. Finally, the new back cover with the new lighting module is mounted in the surrounding wall 41 of the front cover 40, and the changing of the LED light 20 is completed.

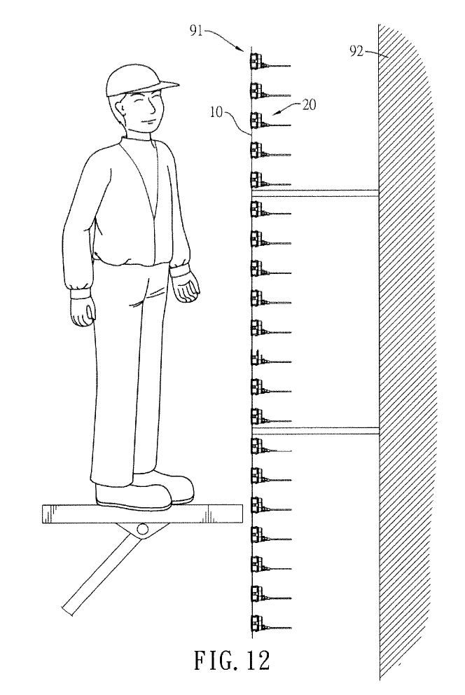

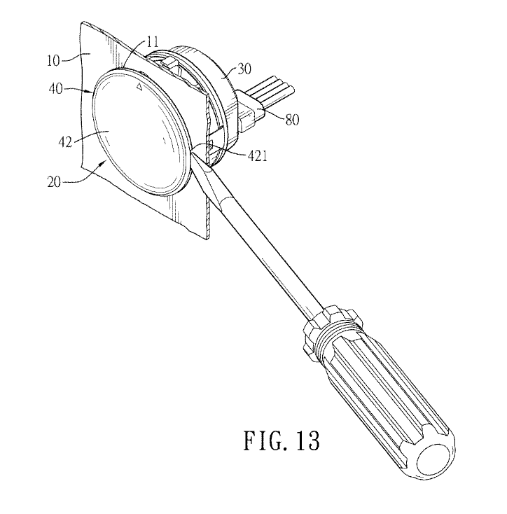

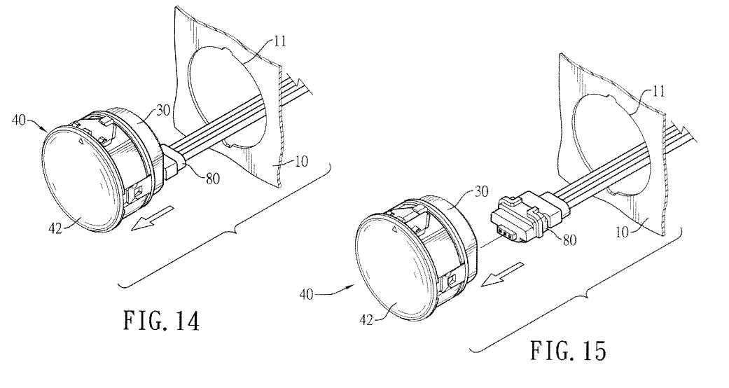

Another disassembling direction is to disassemble the LED lights from the front of the mounting board 10. With reference to FIGS. 12 to 15, when a distance between the billboard and the building is inadequate as shown in FIG. 12, the user can operate in the front of the front cover 40. The user also can use a sharp object to prick into a gap between the lens segment 42 and the mounting board 10 and push forward to eject the LED light 20. Besides, the user also can use a sharp object to prick into the slope recess 421 and push out the LED light 20 as shown in FIG. 13. Then, after the power cord 80 is departed from the lighting module and the back cover 30, the power cord 80 is connected to a new LED light 20. Finally, the new LED light 20 is mounted in and engages the mounting hole 11 of the mounting board 10, and the changing of the LED light 20 is completed.

With reference to FIGS. 3 and 6, with each single LED light 20 having LEDs 52 of different colors, the lights can be mixed to a new color. Besides, the colors of different LED lights 20 on the mounting board 10 also can be different. When the LED lights 20 are installed, the user does not have to know about the color of the LED light 20. The only thing the user has to pay attention to is not interfering with the arrangement of the power cords 80.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED light module comprising:
a mounting board having multiple mounting holes; and
multiple LED lights respectively mounted securely in the mounting holes of the mounting board, and each LED light having
a casing mounted in one of the mounting holes of the mounting board, and having
a back cover having
two back buckling segments; and
a power hole;
a front cover having
two front buckling segments respectively engaging with the back buckling segments; and
a lens segment being transparent and formed on a front side of the front cover; and
an inner cavity formed between the front cover and the back cover;
a lighting module mounted in the inner cavity of the casing, and having
a circuit board; and
at least one LED mounted on the circuit board;
a waterproof gasket mounted on the casing, and mounted between the front cover and the back cover; and
two resilient sheets mounted on an outside wall of the casing, and abutting an annular edge around the corresponding mounting hole of the mounting board.

2. The LED light module as claimed in claim 1, wherein in each LED light
a diameter of the lens segment of the front cover is bigger than a diameter of the mounting hole of the mounting board;
each resilient sheet has an abutting segment; and
the mounting board is clamped between the lens segment of the front cover and the abutting segment of the resilient sheets,

3. The LED light module as claimed in claim 2, wherein in each LED light, the lens segment of the front cover has two slope recesses formed in a periphery of the lens segment.

4. The LED light module as claimed in claim 1, wherein in each LED light
the casing has two connecting segments, and each connecting segment has a front protrusion and a back protrusion; the front side of the back protrusion is a slope; and
the resilient sheets respectively engage with the connecting segments of the casing, and each resilient sheet engages between the front protrusion and the back protrusion.

5. The LED light module as claimed in claim 3, wherein in each LED light
the casing has two connecting segments, and each connecting segment has a front protrusion and a back protrusion; the front side of the back protrusion is a slope; and
the resilient sheets respectively engage with the connecting segments of the casing, and each resilient sheet engages between the front protrusion and the back protrusion.

6. The LED light module as claimed in claim 1, wherein in each LED light
the back cover has an inner cavity, a front side opening and an annular flange formed annularly around an outside wall of the back cover; the back buckling segments of the back cover are formed on the annular flange, and each back buckling segment has a buckling hole;
the front cover covers the opening of the back cover, and has a surrounding wall; the surrounding wall is mounted in the mounting hole of the mounting board, has an inner cavity and two side openings, and is mounted around the back cover;
the waterproof gasket is mounted around the back cover, and is clamped between the annular flange of the back cover and the surrounding wall of the front cover; and
the resilient sheets are mounted on an outside wall of the surrounding wall of the front cover.

7. The LED light module as claimed in claim 5, wherein in each LED light
the back cover has an inner cavity, a front side opening and an annular flange formed annularly around an outside wall of the back cover; the back buckling segments of the back cover are formed on the annular flange, and each back buckling segment has a buckling hole;
the front cover covers the opening of the back cover, and has a surrounding wall; the surrounding wall is mounted in the mounting hole of the mounting board, has an inner cavity and two side openings, and is mounted around the back cover; the connecting segments of the casing are formed on an outside wall of the surrounding wall;
the waterproof gasket is mounted around the back cover, and is clamped between the annular flange of the back cover and the surrounding wall of the front cover; and
the resilient sheets are mounted on the outside wall of the surrounding wall of the front cover.

8. The LED light module as claimed in claim 6, wherein in each LED light, a backside of each front buckling segment of the front cover is a slope.

9. The LED light module as claimed in claim 7, wherein in each LED light, a backside of each front buckling segment of the front cover is a slope.

10. The LED light module as claimed in claim 6, wherein in each LED light, each back buckling segment of the back cover has two separating recesses respectively formed in two opposite sides of the back buckling segment.

11. The LED light module as claimed in claim 9, wherein in each LED light, each back buckling segment of the back cover has two separating recesses respectively formed in two opposite sides of the back buckling segment.

12. The LED light module as claimed in claim 1, wherein each LED light has a refraction lens mounted in the inner cavity of the casing, and mounted between the lens segment of the front cover and the lighting module.

13. The LED light module as claimed in claim 11, wherein each LED light has a refraction lens mounted in the inner cavity of the casing, and mounted between the lens segment of the front cover and the lighting module.

14. The LED light module as claimed in claim 1, wherein in each LED light, the hack cover has two buckles formed oppositely on an annular edge around the power hole of the back cover.

15. The LED light module as claimed in claim 13, wherein in each LED light, the back cover has two buckles formed oppositely on an annular edge around the power hole of the back cover.

16. The LED light module as claimed in claim 1, wherein in each LED light, the lighting module has multiple LEDs, and the LEDs have at least two different colors.

17. The LED light module as claimed in claim 15, wherein in each LED light, the lighting module has multiple LEDs, and the LEDs have at least two different colors.
